(19) United States
(12) Patent Application Publication
(10) Pub. No.: US 2024/0401895 A1
(43) Pub. Date: Dec. 5, 2024

(54) SYSTEM FOR WEAPON IDENTIFICATION, LOCKING AND ADMINISTRATION

(71) Applicant: Zsolt SÖRÖS, Fót (HU)

(72) Inventor: Zsolt SÖRÖS, Fót (HU)

(21) Appl. No.: 18/691,292

(22) PCT Filed: Feb. 17, 2022
(86) PCT No.: PCT/HU2022/000002

§ 371 Date: Mar. 12, 2024

(30) Foreign Application Priority Data
Sep. 16, 2021 (HU) U2100167

(51) Int. Cl. F41A 17/06; H04W 12/79

(52) U.S. Cl. CPC F41A 17/063; H04W 12/79

(57) ABSTRACT

System for weapon identification, locking and administration, characterised in that it comprises mechanical and electronic hardware and computer programs.

The subject of this invention is a system for weapon identification, locking and administration, a multi-functional security system apparatus which is able, using mechanical and electronic hardware and computer programs, to identify firearms of various types, to mechanically lock them, to unlock them for the person entitled to access, to electronically log their position and their status, to store weapon-related data systematically, to generate reports, to execute weapon-related administration tasks, to interoperate with further subsystems, to control modules connected to the system and to monitor the status thereof.

### TECHNICAL BACKGROUND

The subject of the invention according to the patent with Publication Number U.S. Pat. No. 8,464,451B2 is a microprocessor circuit, which is used for surveilling and monitoring firearms. This is performed by the microprocessor circuit, monitoring various sensor and control inputs. Data obtained this way may be used by the microprocessor circuit to determine firearm statistics. These statistics may include the number of times the firearm has been fired, the efficiency of the automatic action of the firearm, the firing distance and the target etc.

The invention according to the patent registered in South Korea with Publication Number KR20090078778A refers to systems and methods for RFID surveillance.

The subject of the invention according to the patent registered in the United States with Publication Number U.S. Pat. No. 8,754,751B1 is an RFID based system and method for vehicle and driver verification. An apparatus and system, which enables wireless receiving, storing and analysis of digital data as part of the number plate of an RFID enabled motor vehicle, in wireless communication with a mobile interrogator. When combined with additional RFID tags, information such as driving licence, VIN code and other user defined information, for example data relating to insurance policy, addresses, registration data, driving records, driving restrictions and similar data may be accessed. Upon receipt of a valid request signal from a law enforcement vehicle, data are wirelessly forwarded through a law enforcement portal to centralized databases for analysis and verification.

The subject of the invention of the patent with Publication Number U.S. Pat. No. 20,140,203913A1 is a tracking device to be embedded in a weapon. The tracking device may be incorporated in the weapon, or may be fixed into the grip or into an other part of the weapon so that the user is not able to see the tracking device or cannot easily remove it. The tracking device would contain a set of data relating to the weapon. The tracking device would be monitored by a reader device. The reader device or a computer connected to the reader device collects the set of data if the tracking device is within a certain distance.

The subject of the patent with Publication Number US20150077255A1 is an invisible concealed weapon identification system. The weapon identification system and method use non-visible markings, locating and tracking system to track and to keep a record of weapons. The weapon is marked by a radio frequency identification tag (RFID) located under the handle or other part of the weapon. The reader of the radio frequency identification tag can be electronically connected to the local network via a computer. Additionally, the reader and the internet network can be linked at national level via a computer, for example by a “cloud” database and by an information sharing system.

The subject of the invention according to the patent with Publication Number US20190287325A1 is a system for detecting and tracking firearms. The system for detecting the presence of firearms comprises a radiofrequency identification (RFID) tag embedded in each firearm. The RFID tag may be passive or active. Using a data structure of an Electronic Product Code (EPC) type, the RFID tag stores a unique data string identifying the manufacturer, the model, the type (object class), the calibre and the unique RFID tag number of the firearm.

### DESCRIPTION OF THE INVENTION

The system for weapon identification, locking and administration is a multi-functional security system apparatus, which is able, using mechanical and electronic hardware and computer programs,
to identify firearms of various types,
to mechanically lock them/to unlock them for the person entitled to access,
to electronically log their position and their status.

Additionally, the system is able.
to store weapon-related data systematically, to generate reports,
to execute weapon-related administration tasks,
to interoperate with further subsystems,
to control modules connected to the system and to monitor the status thereof.

The system uses radio frequency identification (RFID) method for unique identification of weapons. Its physical appearance is a small identification capsule with ferrite core, which does not require independent electric power supply. The RFID capsule is mounted on the surface of the weapon or is embedded in a non-metallic component of the weapon. Embedding may be performed in the manufacturing process of the weapon or, by creating a hole, subsequently. Each RFID capsule contains a unique code suitable for wireless reading. The system links this code to weapon-related data registered, managed or generated in the electronic database.

### Main Components of the System:

Records: data support medium used for identification, suitable only for reading of the unique code wirelessly; it is physically impossible to overwrite its data content. Weapons and their accessories if required, all possess individually this kind of identifying record, which appears as an RFID capsule. This capsule is embedded in the weapon/accessory device or is mounted on the outer surface thereof in a way it is irremovable without destruction.
Users: Users are typically persons possessing certain level of access to the system. The right of access may be an access to weapons or even a right for weapon-related administration activities. Additionally, users possess a personal personalised unique identifier by which the right of access may be exercised. This unique identifier may be knowledge based (for example code, password, information), possession based (for example RFID card/fob, Dallas ibutton, NFC), biometric feature based (for example fingerprint, face/hand geometry, iris/retina geometry) or any combination thereof.
Weapon Lock: fixed or mobilizable electro-mechanical security locking device, which, in its closed state, mechanically prevents from unauthorised access to weapons. The weapon lock comprises smart electronics including also the reader unit of the records (RFID tag), so that it is capable of identifying the weapon placed in it and electronically logging weapon-related events (for example locking, unlocking, sabotage, placement/taking out etc.) The weapon lock is able to work standalone or, connected to a telecommunications network, online/controlled.
Reading Units: task-specific electronic reading device used to read wirelessly the unique identifiers of the Records and of the Users. For processing, it submits the data read to electronics integrated with the reader or to the Control Unit via network, or it may comprise an own memory—even for security reasons—and may be able to store the events. The physical appearance of the Reader Unit may be embedded into the Weapon Lock, may be a wall-mounted spot device, may be a mobile/handheld unit, may be a reader surveilling a physical space, may be a door-mounted reader antenna, or may be any other task-specific design form.
Control Unit: central control electronics, comprising an own memory, in active communication with the Server Unit. It is able, however, to perform normal operation independently in the absence of communication. Its main tasks are surveilling and controlling Weapon Locks, managing outputs and inputs, logging events electronically locally.
Server Unit: industrial computer connecting and managing the Control Units and the Database by an appropriate background of programs. It is the place for adding new/deleting Records and Users, for systematic logging of events and for storing/writing/reading of the Database. Additionally, the Server Unit is able to perform administrative tasks (for example extending the period of weapon-related rights) by the installed programs and, upon a query, is also able to filter the information stored in the Database as needed and to save the results in a secured format, watermarked.
Database: the electronic Database contains the Records and assigned information (for example type of weapon, serial number, authorised user etc.) and the weapon-related logged events; these are recorded here. Logics between the existing, added and generated data are defined here. The Database may be a local Database operating together with the on-site Server Unit or may be even a national/international global Database. Also the Control Units comprise a locally stored Database, in which only a simplified data content is saved (for example Record+User). To keep the content up-to-date, the Control Units are in constant contact with the Database.

The Record (weapon with RFID tag) placed into the Weapon Lock and the associated User are both identified by the Reading Units at the moment of locking. This event is electronically logged. This identification and logging process is repeated when the weapon is picked up (at unlocking). These entries are stored in the Database and the information is further managed by programs running on the Server Unit (for example sending alarm signal to the operator).

The identification and logging processes are not linked to the Weapon Locks. These processes can be performed even by a portable/handheld Reading Unit or by a reading antenna embedded into the door frame structure or, in an other case, by a reading antenna installed in a vehicle or by a spot Reading Unit. The system is able to record the events of the weapons carried on the body and of the accessories thereof and is able to interoperate with and to control further task-specific subsystems.

The system is scalable, the number of Records and of Users does not have upper limit. Depending on the system design, it can be integrated, from the aspect of information technology, into the user interface of existing security systems. Remote connection between computers is also possible via secured network communication. Secured network communication can be established in wired or wireless design form.

### Possible Applications

### Private User, Civil Application

Weapon Lock, designed for civilians, with a storage capacity tailored to the number of weapons; which Weapon Lock ensures secure storage and makes use controllable. The Weapon Locks are integrated compactly with the Reader Unit and with signal processing electronics. Depending on the installation, there may be also a Control Unit installed. The Weapon Locks are capable of network communication and are able to manage further supplementary modules (for example touch screen, numeric keypad, wall-mounted Reader Unit). The Weapon Locks are capable of stand-alone normal operation and are occasionally connected to a personal computer via data cable, through which information is uploaded and downloaded.

### Sport Shooting Clubs, Shooting Ranges

This development line aims at appropriate secure storage of weapons of sport shooting associations on shooting ranges they operate, at ensuring controlled and documented use of weapons during shooting and at increasing the efficiency of administration and logistics processes.

### Weapon Manufacturers

The system provides the weapon manufacturers with an opportunity to apply a weapon identification method meeting the needs of the age by using Reader Units of various designs and with an opportunity to securely store the weapons finished. By embedding the Record (RFID capsule) into the weapon in the process of manufacturing, the system provides the manufacturer with an opportunity of being able to monitor the finished product and to fulfil administrative obligations much more efficiently.

### Law Enforcement and Armed Organisations

For law enforcement organisations, the system, when fully deployed, gives a comprehensive surveillance of manufactured and registered weapons and of the use thereof (weapon database, event database). The system is scalable, that is the number of Records, of Users and of modules connected to and surveilled by the management software does not have upper limit. The local systems deployed may be fixed to locations (for example police station), or may be mobile (not fixed to a location) systems (for example vehicle). These are demonstrated below by the simplified block diagrams of the system.

### DESCRIPTION OF FIGURES

FIG. 1: shows the block diagram of the system installed on a location. The centre of the system is the Central Server (3), to which the Central Database (2) is connected. The data of the Central Database (2) are accessed by the Handheld Reading and Mobile Systems (1) via wireless connection. Systems installed on locations (for example police station, shooting club etc.) connected to the Central Server (3) via secured network (6) are built up similarly to the central system; a Local Server (7) and a Local Database (8) make up their “brains”, to which the identifying devices (10) and the Weapon Locks (5) themselves are connected through a controller (9). If required, a personal computer (4) may be connected to the Central Server (2), enabling the system to be used by private users. Weapon Locks (5) may be connected also to the personal computer (4).

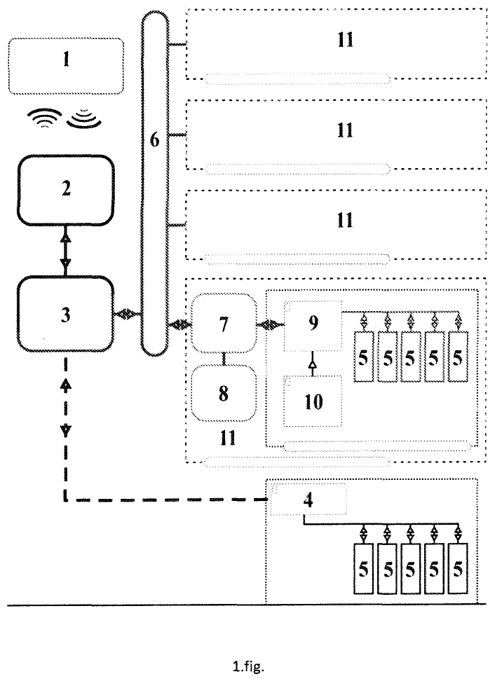

FIG. 2: shows the block diagram of the mobile system, which is not fixed to a location. The main difference compared to FIG. 1 is that the locations (11) may be even moving units, for example police vehicles. Consequently, the Central Database (2), which operates in connection with the Central Server Unit (12), is accessed by the units/locations (11) via secured communication in any case, even wireless. This may be even a GSM network connection; also the local control unit (15), containing the local database and the event recorder, uses that to access the Central Server Unit (12). The Weapon Locks (5) can be connected to the local control unit (15) via communication bus. Other peripheral devices (16) may be also connected thereto. The Handheld Reading and Mobile Systems (1) can be connected via wireless network to the mobile system.

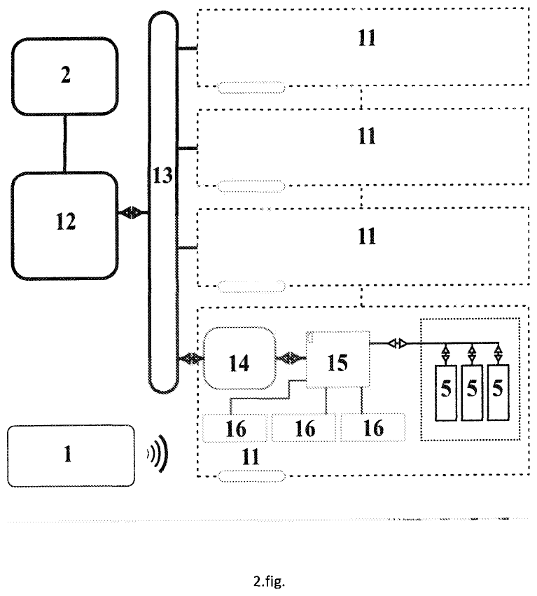

1. System for weapon identification, locking and administration, characterised in that it comprises mechanical and electronic hardware and computer programs.

2. The invention according to claim 1, characterised in that it is able to identify firearms of various types, to mechanically lock them, to unlock them for the person entitled to access, to electronically log their position and their status.

3. The invention according to claim 1, characterised in that the system is able to store weapon-related data systematically, to generate reports, to execute weapon-related administration tasks, to interoperate with further subsystems, to control modules connected to the system and to monitor the status thereof.

4. The invention according to claim 1, characterised in that it uses radio frequency identification (RFID) method for unique identification of weapons.

5. The invention according to claim 1, characterised in that the RFID capsule is mounted on the surface of the weapon or is embedded in a nonmetallic component of the weapon.

6. The invention according to claim 1, characterised in that the system comprises the following components: Records, Users, Weapon Lock, Reading Units, Control Unit, Server Unit, Database.

7. The invention according to claim 1, characterised in that a Record (weapon with RFID tag) placed into the Weapon Lock and an associated User are both identified by Reading Units at the moment of locking.

8. The invention according to claim 7, characterised in that entries generated during locking are stored in a Database and information is further managed by programs running on a Server Unit.
